(19) United States
(12) Patent Application Publication
(10) Pub. No.: US 2007/0174824 A1
(43) Pub. Date: Jul. 26, 2007

(54) Techniques for generating and executing browser-hosted applications

(75) Inventors: David P. Relyea, Bellevue, WA (US); Vivek B. Dalvi, Bellevue, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/337,637

(22) Filed: Jan. 23, 2006

(51) Int. Cl. G06F 9/45

(52) U.S. Cl. 717/140

(57) ABSTRACT

Techniques are provided for compiling source code. A first code portion is generated that corresponds to the source code and is included in an application program. An attribute setting is received indicating an execution environment for the application program. A second code portion included in the application program is conditionally generated in accordance with the attribute setting. A determination is made as to whether the attribute setting is a first value indicating a first execution environment. If the attribute setting is the first value, a deployment manifest file and an application manifest filed are generated. The manifest files are used in connection with installation of the application program for execution in the first execution environment.

### BACKGROUND

Application programs may be written to execute in a variety of different environments. For example, a developer may write a program. The developer may want the program to be executed as a standalone application on a user's computer. The developer may also want the same program to be executed as a web-based application in which the program runs in the browser. In order to write the program, the developer may have different programming models for the different execution environments which may complicate program development. In other words, the way in which a developer produces code to run in each of the different execution environments may vary. The developer may have to use different toolsets, libraries, and the like, for the different execution environments in order to have the same program execute in each of the different environments. Even in situations in which a same library, for example, may be used by the program in multiple execution environments, the developer may still have to manually adapt the remaining portions of the program for execution in each of the different environments.

### SUMMARY

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Techniques are provided for compiling source code to generate an application program, and in connection with installation and activation of the application program. In connection with compiling the source code, a first code portion is generated that corresponds to the source code and is included in an application program. An attribute setting is received indicating an execution environment for the application program. A second code portion included in the application program is conditionally generated in accordance with the attribute setting. A determination is made as to whether the attribute setting is a first value indicating a first execution environment. If the attribute setting is the first value, a deployment manifest file and an application manifest filed are generated. The manifest files are used in connection with installation of the application program for execution in the first execution environment.

### DESCRIPTION OF THE DRAWINGS

Features and advantages of the present invention will become more apparent from the following detailed description of exemplary embodiments thereof taken in conjunction with the accompanying drawings in which:

FIG. 1 is an example of an embodiment illustrating an environment that may be utilized in connection with the techniques described herein;

FIG. 2 is an example of components that may be included in an embodiment of a user computer for use in connection with performing the techniques described herein;

FIG. 3 is an example illustrating data flow between some of the components of FIG. 2 in connection with compilation for a browser-hosted application;

FIG. 4 is a flowchart of processing steps that may be performed in an embodiment in connection with compilation using the techniques described herein;

FIG. 5 is an example illustrating data flow between some of the components of FIG. 2 in connection with installation and execution of the browser-hosted application using the techniques described herein; and

FIG. 6 is a flowchart of processing steps that may be performed in an embodiment in connection with installation and execution of a browser-hosted application using the techniques described herein.

### DETAILED DESCRIPTION

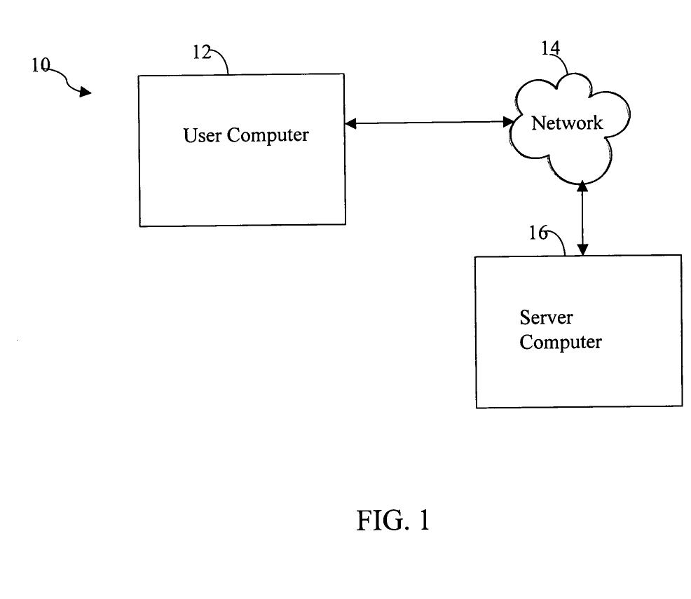

Referring now to FIG. 1, illustrated is an example of a suitable computing environment in which embodiments utilizing the techniques described herein may be implemented. The computing environment illustrated in FIG. 1 is only one example of a suitable computing environment and is not intended to suggest any limitation as to the scope of use or functionality of the techniques described herein. Those skilled in the art will appreciate that the techniques described herein may be suitable for use with other general purpose and specialized purpose computing environments and configurations. Examples of well known computing systems, environments, and/or configurations include, but are not limited to, personal computers, server computers, hand-held or laptop devices, multiprocessor systems, microprocessor-based systems, programmable consumer electronics, network PCs, minicomputers, mainframe computers, distributed computing environments that include any of the above systems or devices, and the like.

The techniques set forth herein may be described in the general context of computer-executable instructions, such as program modules, executed by one or more computers or other devices. Generally, program modules include routines, programs, objects, components, data structures, and the like, that perform particular tasks or implement particular abstract data types. Typically the functionality of the program modules may be combined or distributed as desired in various embodiments.

Included in FIG. 1 is a user computer 12, a network 14, and a server computer 16. The user computer 12 may include a standard, commercially-available computer or a special-purpose computer that may be used to execute one or more program modules. Described in more detail elsewhere herein are program modules that may be executed by the user computer 12 in connection with the techniques described herein. The user computer 12 may operate in a networked environment and communicate with the server computer 16 and other computers not shown in FIG. 1.

It will be appreciated by those skilled in the art that although the user computer is shown in the example as communicating in a networked environment, the user computer 12 may communicate with other components utilizing different communication mediums. For example, the user computer 12 may communicate with one or more components utilizing a network connection, and/or other type of link known in the art including, but not limited to, the Internet, an intranet, or other wireless and/or hardwired connection(s).

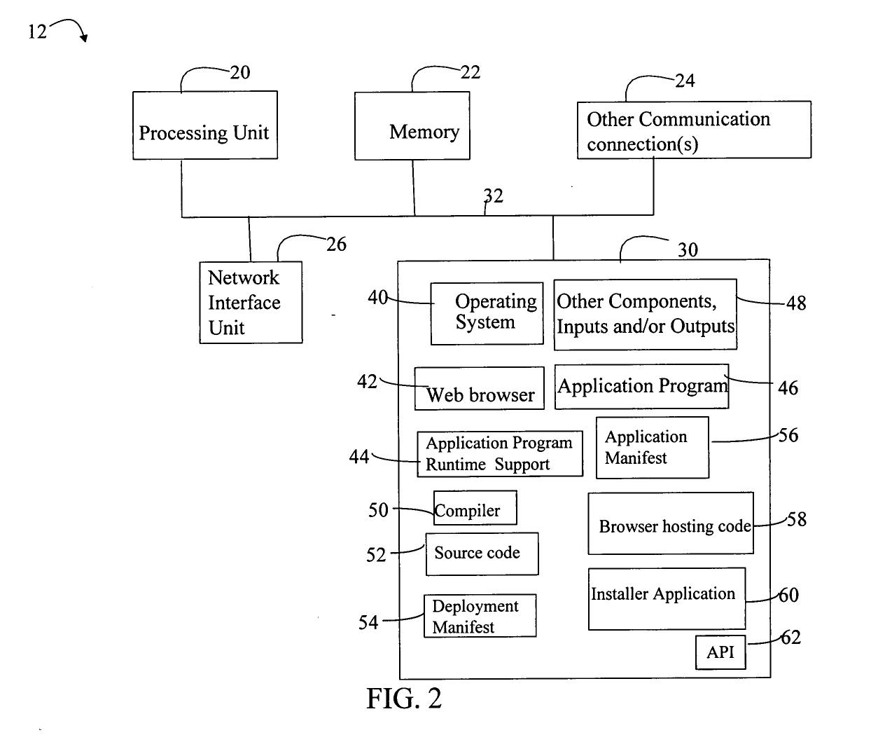

Referring now to FIG. 2, shown is an example of components that may be included in a user computer 12 as may be used in connection with performing the various embodiments of the techniques described herein. The user computer 12 may include one or more processing units 20, memory 22, a network interface unit 26, storage 30, one or more other communication connections 24, and a system bus 32 used to facilitate communications between the components of the computer 12.

Depending on the configuration and type of user computer 12, memory 22 may be volatile (such as RAM), non-volatile (such as ROM, flash memory, etc.) or some combination of the two. Additionally, the user computer 12 may also have additional features/functionality. For example, the user computer 12 may also include additional storage (removable and/or non-removable) including, but not limited to, USB devices, magnetic or optical disks, or tape. Such additional storage is illustrated in FIG. 2 by storage 30. The storage 30 of FIG. 2 may include one or more removable and non-removable storage devices having associated computer-readable media that may be utilized by the user computer 12. The storage 30 in one embodiment may be a mass-storage device with associated computer-readable media providing non-volatile storage for the user computer 12. Although the description of computer-readable media as illustrated in this example may refer to a mass storage device, such as a hard disk or CD-ROM drive, it will be appreciated by those skilled in the art that the computer-readable media can be any available media that can be accessed by the user computer 12.

By way of example, and not limitation, computer readable media may comprise computer storage media and communication media. Memory 22, as well as storage 30, are examples of computer storage media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, (DVD) or other optical storage, magnetic cassettes, magnetic tape, magnetic disk storage or other magnetic storage devices, or any other medium which can be used to store the desired information and which can accessed by user computer 12. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The user computer 12 may also contain communications connection(s) 24 that allow the user computer to communicate with other devices and components such as, by way of example, input devices and output devices. Input devices may include, for example, a keyboard, mouse, pen, voice input device, touch input device, etc. Output device(s) may include, for example, a display, speakers, printer, and the like. These and other devices are well known in the art and need not be discussed at length here. The one or more communications connection(s) 24 are an example of communication media.

In one embodiment, the user computer 12 may operate in a networked environment as illustrated in FIG. 1 using logical connections to remote computers through a network. The user computer 12 may connect to the network 14 of FIG. 1 through a network interface unit 26 connected to bus 32. The network interface unit 26 may also be utilized in connection with other types of networks and/or remote systems and components.

One or more program modules and/or data files may be included in storage 30. During operation of the user computer 12, one or more of these elements included in the storage 30 may also reside in a portion of memory 22, such as, for example, RAM for controlling the operation of the user computer 12. The example of FIG. 2 illustrates various components including an operating system 40, a web browser 42, application program runtime support 44, one or more application programs 46, a compiler 50, source code 52, a deployment manifest 54, an application manifest 56, browser hosting code 58, an installer application 60, one or more APIs 62, and other components, inputs, and/or outputs 48. The operating system 40 may be any one of a variety of commercially available or proprietary operating system. The operating system 40, for example, may be loaded into memory in connection with controlling operation of the user computer. One or more application programs 46 may execute in the user computer 12 in connection with performing user tasks and operations.

In connection with generating the application program 46, a developer may desire the application program to be executed in multiple execution environments. For example, a developer may want the program to be able to execute as a standalone application on a user's computer. The developer may also want the same program to be able to execute as a web-based application in which the program runs or executes in the browser. An application which executes or runs in the web browser may also be referred to as a browser-hosted application. As known to those skilled in the art, the application program may include different code portions in accordance with the particular execution environment in which the application program will execute. For example, an application program which executes in the context of a web browser as a browser-hosted application may perform a first set of processing steps in order to enable such execution context. The first set of processing steps may be different that those performed by the application program when executing as a standalone application such as, for example, when invoked from the start menu or from a command line on a user computer.

What will be described in following paragraphs are techniques that may be used in connection with generating, installing and activating for execution browser-hosted applications. Techniques are described herein that may be used to streamline the development process in connection with generating the application program for execution in different execution environments. The techniques provide for automated generation of code through a compilation attribute setting in accordance with the particular execution environment. If the compilation attribute setting indicates that the application program is to execute as a browser-hosted application, the compiler also generates additional files for use in connection with installation and execution of the application program. The installation and activation of the application program may be characterized as an automated process initiated by the web browser. The browser-hosted application executes in the same window as the web browser in a context similar to when a user navigates to a new web page. In other words, from the user perspective, the program execution is displayed, for example, within the web browser window as if the user has navigated to another HTML page. This is in contrast to the behavior a user may see when starting the application program as a standalone application without the browser, such as from the start menu or from the command line, in which the application executes in a separate window. With a browser-hosted application, the web browser functionality is available for use with the application program execution.

In one embodiment of the techniques described herein, the ClickOnce deployment technology which is included as part of V2.0 and later versions of the .NET™ framework by Microsoft Corporation may be utilized. The ClickOnce deployment technology may be used for installation and activation of the application program as a browser-hosted application. The techniques described herein facilitate application program development by providing for automated generation of code portions using a compiler attribute setting in accordance with particular runtime environment of the application program.

In connection with development of the application program 46, source code may be written and then compiled, as with the compiler 50. The compiler may compile the source code and generate the application program which includes a first code portion corresponding to the source code and other code portions which may vary with execution environment. The code portions that may vary with execution environment may include glue code portions, or glue code, enabling the first code portion of compiler generated code to execute in accordance with the particular execution environment. For example, the compiler may generate a first glue code portion included in the application program if the application program will be executing as a browser-hosted application. The compiler may alternatively generate a different second glue code portion included in the application program if the application program will be executing as a standalone application. The glue code portions generated by the compiler may be included in a main routine or method.

In one embodiment using the .NET™ framework, attribute settings may be specified in a project file. The attribute settings specify compilation options affecting output generated by the compiler. In connection with techniques described herein, a setting may be specified for the attribute HostInBrowser. When a developer wants the compiler to generate any additional necessary code so that the application program is able to execute as a browser-hosted application, such as the foregoing glue code for this execution environment, a value of TRUE may be specified for the HostInBrowser attribute in the project file. If the value of this attribute is false, the compiler generates code in accordance with executing the application as a standalone application. It will be appreciated by those skilled in the art that the compilation option or setting which serves as an indicator to the compiler to generate code for the application program executing as a browser-hosted application may be communicated to the compiler in a variety of other ways which may vary in accordance with the particular compiler. Additionally, it should be noted that although the foregoing attribute is a boolean value, an attribute having more than two states may also be used.

In addition to affecting the glue code portions generated by the compiler, the HostInBrowser attribute setting may determine whether additional files are generated in order to allow the application program to be installed and activated for execution as a browser-hosted application. In one embodiment, the compiler may also generate a deployment manifest 54 and an application manifest 56. The deployment manifest 54, application manifest 56 and their use in installation and activation of an application are described in more detail in pending U.S. patent application Ser. No. 10/909,217, filed Jul. 30, 2004, “Framework to Build, Deploy, Service, and Manage Customizable and Configurable Re-usable Applications”, MS Reference No. 304271.2, which is incorporated by reference herein.

In connection with the techniques described herein, the deployment manifest and application manifest are used in connection with the browser-hosted application. The deployment manifest and the application manifest may be files in accordance with the particular file system in an embodiment. Each of the manifests includes information used in installation and/or activation of the application program in connection with the techniques described herein. The deployment manifest 54 may be characterized as containing information associated with deployment of the associated application program. The deployment manifest 54 may include, for example, the name and version information of the application program, and an identifier or pointer to the application manifest 56. An embodiment may also utilize digital signatures as a security measure in connection with digitally signing the manifests 54 and 56. In such embodiments, the deployment manifest 54 may include the necessary information to digitally sign and later decrypt the deployment manifest 54 and/or the application manifest 56. Although such information may vary in accordance with the digital signature technique, such information may include, for example, the public key used in decryption, a digital certificate and an identifier of the particular signature method. The compiler may output this information which may be used at a later time in digitally signing the manifests and then decrypting the manifests in connection with installation of the application.

The application manifest 56 may be characterized as identifying the runtime dependencies or prerequisite information about the application program. Such runtime dependency information may include the libraries, such as DLLs, and other files which are necessary for the application program to execute. The application manifest 56 may also include the execution entry point in the application program and identify the minimum security permissions to execute the application program. With reference to FIG. 2, the runtime dependencies of the application program may be collectively represented by the application program runtime support 44. Portions of 44 may be included as part of the operating system and other environment such as the .NET™ framework by Microsoft Corporation. The browser hosting code 58, installer application 60, and API 62 may be included as components of an operating system.

The web browser 42, application manifest 56 and deployment manifest 54 along with the application program runtime support 44, browser hosting code 58, installer application 60 and API 62 are used in connection with installation and activation of the application program as a browser-hosted application. This is described in more detail herein.

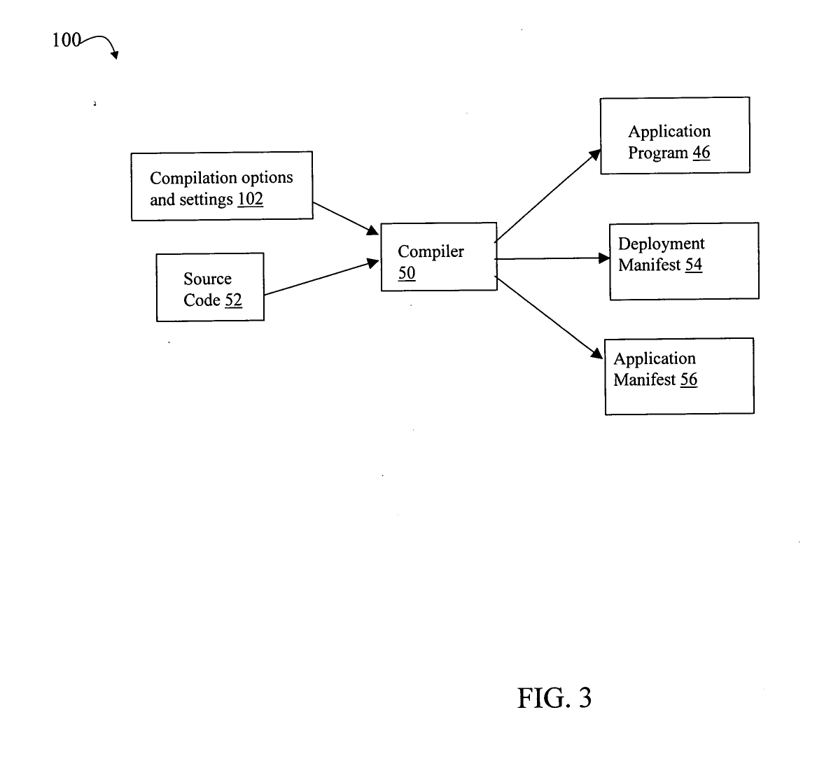

Referring now to FIG. 3, shown is an example 100 illustrating the data flow between some of the components of FIG. 2 just described in connection with the compilation process. The compiler 50 compiles source code 52. Other inputs to the compiler may include compilation options and settings that may be specified in any one of a variety of different ways in accordance with the particular compiler. In one embodiment as just described, compilation options such as attribute option HostInBrowser may be specified in a project file associated with the compiler. The compiler 50 may output an application program 46 including code portions in accordance with the input source code, and glue code portions in accordance with the HostInBrowser option setting. If the HostInBrowser option is true indicating the execution environment of the application program as a browser-hosted application, the compiler 50 may also generate a deployment manifest 54 and an application manifest 56.

It should be noted that the compiler may generate other files than as described herein.

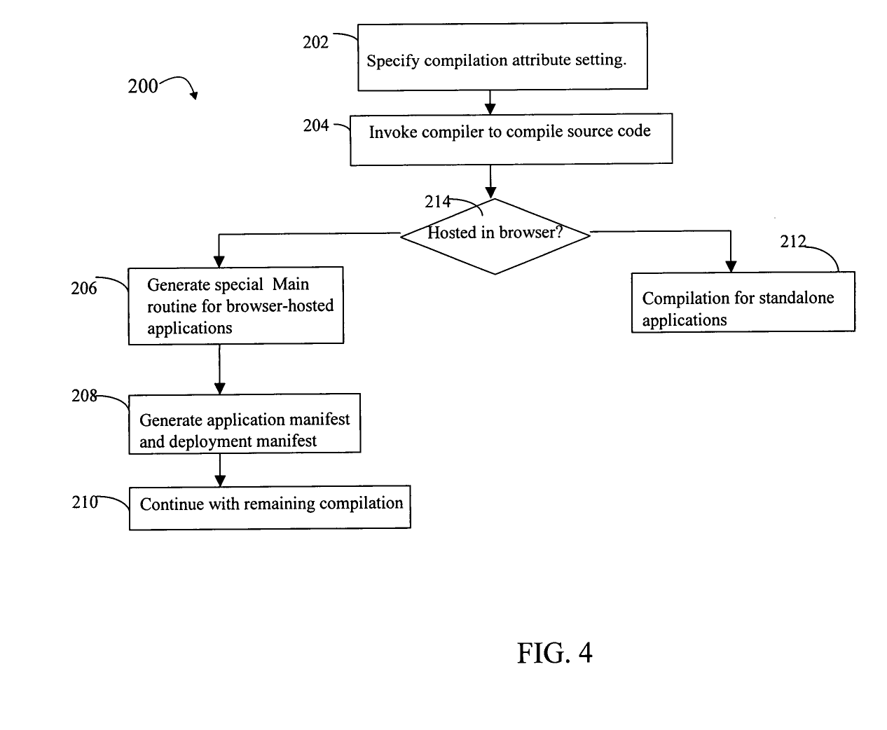

Referring now to FIG. 4, shown is a flowchart 200 summarizing the processing steps just described in connection with compilation using the techniques described herein. At step 202, a compilation attribute setting for HostInBrowser is specified, for example, in the project file. At step 204, the compiler is invoked to compile source code in accordance with the compilation attribute settings from step 202. At step 214, a determination is made by the compiler as to whether the HostInBrowser attribute is set. If not, control proceeds to step 212 to continue the compilation process for a standalone application. If the HostInBrowser option is set, control proceeds from step 214 to step 206 where the special version of the main routine or method is generated for browser-hosted applications. Code for this special main routine or method is included in the application program generated by the compiler. The special main routine may be characterized as including the glue code to enable execution of the application program as a browser-hosted application. In one embodiment in connection with the standalone application, the compiler generates a main routine or method which includes code to initialize the application program and also code causing execution of the non-glue code portions (e.g., corresponding to the source code). In connection with the browser-hosted application, the special main routine generated by the compiler includes code to initialize the application program but does not include code causing execution of the non-glue code portions. At step 208, the compiler generates the application manifest and deployment manifest. At step 210, the compiler continues with the remaining compilation processing steps.

What will now be described is processing that may be performed in connection with installation and execution of the application program as a browser-hosted application. In other words, the processing steps that will now be described may be used to execute the application program produced via compilation with the HostInBrowser attribute set as described above.

In connection with the embodiment described herein, the deployment manifest file may be used as the file triggering other processing steps for installation and activation of the application program. The deployment manifest file may be used in a variety of different ways to trigger subsequent processing steps. The deployment manifest file may have a file name extension, such as “.xbap”. The browser hosting code 58 may be registered as the file extension handler and as the MIME-type handler for processing the deployment manifest in accordance with the particular extension used for the deployment manifest file. The browser hosting code 58 may be on the user computer and may be included in connection with the operating system. The browser hosting code 58 may be used in connection with performing the subsequent processing steps.

In connection with a first technique, the user may be executing a web browser on the user computer. The deployment manifest file may be selected, as using a mouse or other selection device, via an HTTP (hyper text transport protocol) link that may be included in a displayed web page in the web browser. The link may include a designation such as http:/www.myserver.com/myapp.xbap which references the location of the deployment manifest file. The deployment manifest file may be located on the server computer 16. In response to the user selection, the web browser is navigated to the URL associated with the deployment manifest file. The web browser then issues a request to the server computer for the deployment manifest file. The deployment manifest is downloaded to the user computer from the server computer 16 in response to the request. The server computer 16 also returns the particular MIME-type for the deployment manifest file. The web browser passes control to the browser hosting code 58 which is registered as the handler for the MIME-type associated with the deployment manifest file. In a variation of the foregoing, a user may also navigate the web browser to the deployment manifest by entering the URL indicating the deployment manifest file rather than via selection of a displayed link. It should be noted that the deployment manifest may also be located on the user computer or other location specified via the selected link or by the user entering the URL in the web browser.

The deployment manifest file may also be selected by the user without having the web browser initially executing. For example, the user may select the deployment manifest file by clicking on the deployment manifest file as may be displayed in a file directory listing. The browser hosting code 58 may be registered as the file extension handler for the file type of the deployment manifest file and may be accordingly invoked. The browser hosting code 58 may then invoke the default web browser and navigate the web browser to the deployment manifest file. From this point, processing may proceed as described above in which the browser hosting code 58 is again invoked as a result of being registered as the handler for the MIME-type associated with the deployment manifest file.

Using any of the foregoing, once the browser hosting code 58 is invoked as a result of being registered as the handler for the MIME-type associated with the deployment manifest file, the browser hosting code 58 may start any necessary components associated with a runtime environment in accordance with the application program. For example, the .NET™ framework has a common language runtime (CLR) which may be started. In connection with starting the runtime environment of the CLR, the .NET™ framework may automatically perform processing related to initialization of the application program and loading the application program into memory. One step that the .NET™ framework may automatically perform includes execution of the main routine or method. In this instance, the main routine or method is the special version as described elsewhere herein in which the call resulting in actual execution of the application program has been omitted from the main routine. After the .NET™ framework is started, control returns to the browser hosting code.

The browser hosting code 58 then launches an installer application 60 which drives the installation and activation of the application program 46. The installer application 60 may invoke one or more APIs (application programming interfaces) 62 in connection with installation of the application program. In connection with the techniques described herein, the installer application may be invoked from, and execute within, an execution context of the web browser.

The installer application 60 may invoke a first API which downloads the deployment and application manifest files from the location, such as from the server computer 16. The location of the application manifest file may be determined as specified in the deployment manifest file described elsewhere herein. The first API may also perform other processing such as a first portion of validation processing that may be associated with the manifest files. For example, validation processing may include performing schema, semantic and/or signing validation as may be included in an embodiment. The schema and semantic processing may include, for example, verifying that the manifest file formats are as expected including defined values and fields. Signing validation may include, for example, decrypting the manifest files in accordance with a public key. The use of digital signatures may be used in an embodiment to ensure that the manifest files have not changed since the time they were signed. Depending on the particular digital signature, an identity of a publisher or producer of the manifest files and/or application program may also be determined.

The installer application may also call a second API in connection with validating the application's runtime dependencies in accordance with the application manifest file. As an example, if the application manifest file indicates that a first runtime library or DLL is required to be installed for use in connection with execution of the application program 46, the second API verifies that this library is installed on the user computer where the installation is being performed. In connection with this second API, any required security settings or permissions (e.g., as may be specified in the application manifest file) needed to execute the application program may be verified.

The installer application may also perform processing to download the application program from the server computer, if needed. In one embodiment, the installer application may check to see if there is already an existing version of the application program on the user computer such as, for example, by looking for an existing deployment manifest file on the user computer. The existing version as indicated in the existing deployment manifest file may be compared to the latest version of the application program as indicated in the deployment manifest file downloaded from the server computer. In the event that there is no existing application version on the user computer, or that the existing application version is not the latest version, the installer application may perform the downloading of the application program from the server computer to the user computer by invoking a third API.

It should be noted that if an error occurs in any of the foregoing processing steps related to installation of the application program, an error page may be displayed to the user. For example, if a runtime dependency is not installed on the user computer, an error page may be displayed via the web browser indicating this along with a list of the one or more dependencies which are not installed on the user computer.

During the download of the application program, an embodiment may display a progress bar in the browser regarding the progress of the application program download. A cancel button may also be displayed with the progress bar so that the user may cancel the download. Once the application program has been downloaded, the installer application may invoke another API which results in execution of the application program using the entry point of the application program as indicated in the application manifest file described elsewhere herein. The invocation of this last API results in invocation of the application program running in the same window as the web browser as a browser-hosted application.

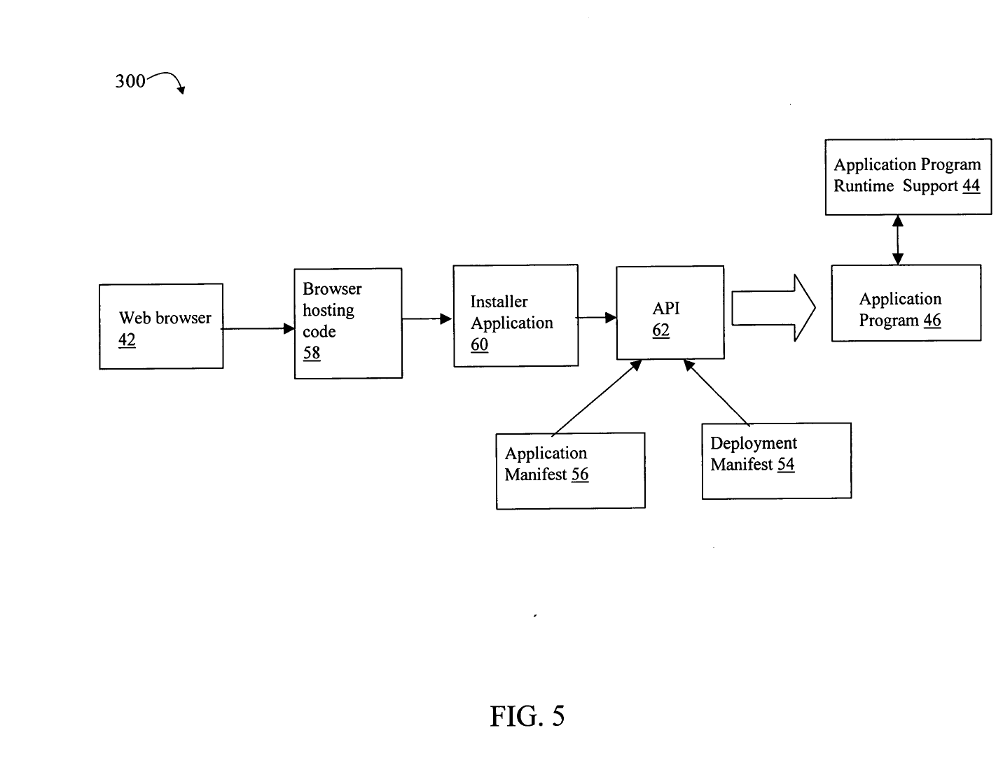

Referring now to FIG. 5, shown is an example illustrating the data flow between components used in connection with installation and activation of the application program. The example 300 includes a web browser 42 from which the browser hosting code 58 is executed. The browser hosting code 58 invokes an installer application 60 which utilizes one or more APIs 62 in connection with the installation and activation process. The particular APIs that may be invoked in an embodiment and the associated processing steps are described elsewhere herein. The APIs 62 download the manifest files 54 and 56 and perform processing using these files. The APIs 62 may be used in connection with downloading the application program 46 if needed. The APIs 62 may also be used in connection with starting execution of the application program 46 which uses the application runtime support 44 during its execution.

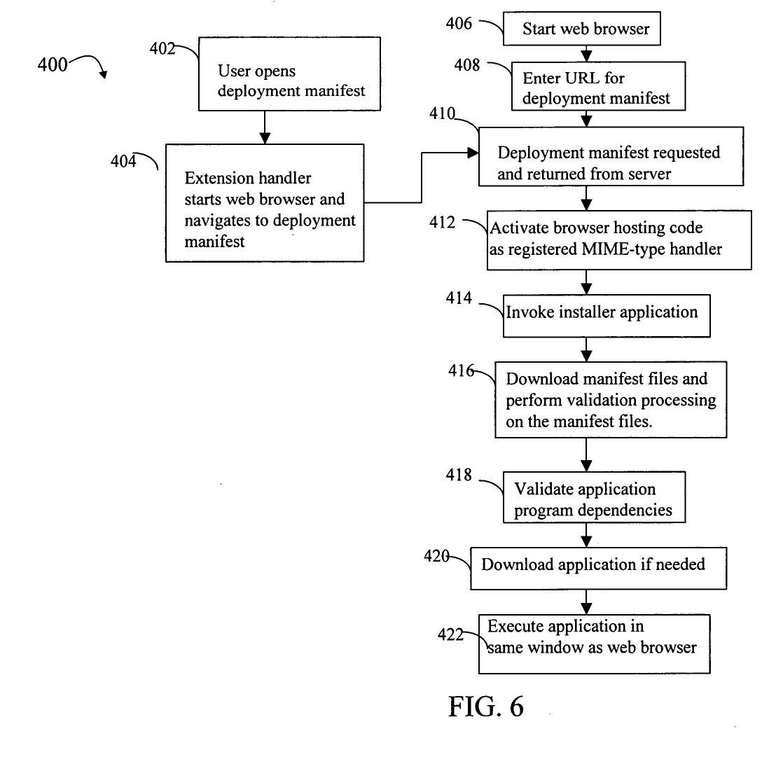

Referring now to FIG. 6, shown is a flowchart 400 of processing steps that may be performed in an embodiment in connection with installation and activation of the application program. FIG. 6 summarizes the processing steps just described. The flowchart 400 illustrates two paths leading to step 410 in connection with the different ways in which the techniques described herein may be utilized. At step 402, the user may open the deployment manifest file. Step 402 may be performed, for example, by selecting the deployment manifest file as from a directory listing of files causing the deployment manifest file to be opened using an appropriate operating system shell. The selection at step 402 results in execution of step 404 where the registered file extension handler associated with the file extension type of the deployment manifest file is invoked. As part of step 404, the file extension handler starts the web browser and navigates the web browser to the deployment manifest file. Control then proceeds to step 410.

In connection with a second path, the user starts the web browser at step 406. At step 408, the URL for the deployment manifest file is either entered by the user or selected via a displayed web page causing the web browser to navigate to the deployment manifest file. Control then proceeds to step 410.

At step 410, the deployment manifest file is requested and returned from the server computer. At step 412, the browser hosting code is invoked. The browser hosting code is registered as the MIME-type handler associated with the MIME-type of the deployment manifest file. At step 414, the installer application is invoked. At step 416, the installer may invoke an API to download the manifest files and perform a first portion of the validation processing on the files. The validation processing performed at step 416 may include schema, semantic, and/or signing validation. An API may also be invoked in connection with performing step 418 to validate the application program's runtime dependencies. At step 420, the application program may be downloaded to the user computer if needed. At step 422, the application begins execution within the same window as the web browser. In other words, the application begins execution as a browser-hosted application.

In one embodiment of the techniques described herein, the ClickOnce deployment technology which is included as part of V2.0 and later versions of the .NET™ framework by Microsoft Corporation may be utilized. The ClickOnce deployment technology may be used for installation and activation of the application program as a browser-hosted application. The techniques described herein facilitate application program development by providing for automated generation of code portions using a compiler attribute setting in accordance with particular runtime environment of the application program.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method of compiling source code comprising:
generating a first code portion that corresponds to said source code and is included in an application program;
receiving an attribute setting indicating an execution environment for said application program;
conditionally generating, in accordance with said attribute setting, a second code portion included in said application program;
determining whether said attribute setting is a first value indicating a first execution environment; and
if said attribute setting is said first value, generating a deployment manifest file and an application manifest file used in connection with installation of said application program for execution in said first execution environment.

2. The method of claim 1, wherein said first execution environment is a browser-hosted application environment.

3. The method of claim 2, wherein said attribute setting indicates whether said application program is a standalone application or a browser-hosted application, said browser-hosted application being an application which executes in a same context as a web browser.

4. The method of claim 3, wherein selection of an identifier from within a web browser causing execution of the application program causes the application program to execute in a same window as said web browser as if a user has selected another web page.

5. The method of claim 1, wherein said deployment manifest file and said application manifest file are used in installation of said application program in a browser-hosted application environment.

6. The method of claim 5, wherein said deployment manifest file includes an application version identifier associated with a version of said application program and an identifier indicating a location of said application manifest file.

7. The method of claim 6, wherein said application manifest file identifies runtime dependencies of said application program.

8. The method of claim 7, wherein said runtime dependencies include a library.

9. A method for installing and activating a program comprising:
executing a web browser;
invoking an installation application from within an execution context of said web browser;
installing, by said installation application, said program; and
activating, by said installation application, execution of said program within said web browser.

10. The method of claim 9, wherein said execution of said program is viewed in a same window as said web browser.

11. The method of claim 9, wherein installation of said program in said installing step is viewed in a same window as said web browser.

12. The method of claim 9, wherein installation of said program in said installing step and execution of said program are performed in a same context in said web browser as when a user navigates to a web page.

13. The method of claim 9, wherein said application program includes a main routine which is generated automatically by a compiler in accordance with a compilation option setting.

14. The method of claim 13, further comprising:
starting a runtime support environment which automatically executes said main routine, said starting step being performed prior to execution of said installer application.

15. The method of claim 9, wherein said installation program invokes a first application programming interface in connection with downloading a deployment manifest file and an application manifest file.

16. The method of claim 15, wherein said installation program invokes at least a second application programming interface in connection with performing validation processing using said manifest files.

17. The method of claim 16, wherein said installation program invokes a third application programming interface in connection with activating execution of said program.

18. A computer readable medium comprising executable code for performing processing steps for installing and activating a program comprising:
selecting a deployment manifest file having an extension type;
executing a handler registered to process files having said extension type;
executing, by said handler, a web browser;
invoking an installation application from within an execution context of said web browser;
installing, by said installation application, said program; and
activating, by said installation application, execution of said program within said web browser.

19. The computer readable medium of claim 18, wherein said deployment manifest file and said application are stored on a server computer and are downloaded to another computer.

20. The computer readable medium of claim 18, wherein said execution of said program is viewed in a same window as said web browser.
